(19) United States
(12) Patent Application Publication
(10) Pub. No.: US 2021/0365553 A1
(43) Pub. Date: Nov. 25, 2021

(54) CONTROL DEVICE AND CONTROL METHOD

(71) Applicant: SONY SEMICONDUCTOR SOLUTIONS CORPORATION, KANAGAWA (JP)

(72) Inventor: HIROYUKI HIRANO, SAN JOSE, CA (US)

(21) Appl. No.: 16/964,595

(22) PCT Filed: Oct. 26, 2018
(86) PCT No.: PCT/JP2018/039869

§ 371 Date: Jul. 23, 2020

Related U.S. Application Data
(60) Provisional application No. 62/627,552, filed on Feb. 7, 2018.

(51) Int. Cl. G06F 21/55; G06F 21/73; G06F 21/75; G06F 21/84

(52) U.S. Cl. CPC G06F 21/556; G06F 21/84; G06F 21/75; G06F 21/73

(57) ABSTRACT

To provide a control device capable of minimizing side-channel leaks that can be generated before completion of an analog-to-digital conversion by a PUF implemented as a physical parameter and making attacks difficult. The control device provided includes a device unit that has regularly arranged analog devices such as pixel array, and a readout control unit that executes readouts that are a mixture of a real PUF readout (first readout) that generates unique information for the device unit and a dummy PUF readout (second readout) that does not generate unique information for the device.

### TECHNICAL FIELD

The present disclosure relates to a control device and a control method.

### BACKGROUND ART

As a solid-state imaging device, an amplification-type solid-state imaging device represented by a MOS image sensor such as a complementary metal oxide semiconductor (CMOS) is known. Furthermore, a charge transfer type solid-state imaging device represented by a charge coupled device (CCD) image sensor is known. These solid-state imaging devices are widely used in digital still cameras, digital video cameras, and the like. In recent years, MOS image sensors are often used as solid-state imaging devices mounted on mobile devices such as camera-equipped mobile phones and personal digital assistants (PDAs) because of their low power supply voltage, power consumption, and the like. For example, Patent Document 1 discloses an example of a digital camera to which such a solid-state imaging device is applied.

In a MOS solid-state imaging device, a unit pixel is formed by using a photodiode serving as a photoelectric conversion unit and a plurality of pixel transistors, and is constituted by a pixel array (pixel area) in which a plurality of the unit pixels is arrayed in a two-dimensional array, and a peripheral circuit area. The plurality of pixel transistors is formed by using MOS transistors, and is constituted by three transistors including a transfer transistor, a reset transistor, and an amplification transistor, or four transistors further including a selection transistor.

In recent years, attention has been paid to a technology called a physically unclonable function (PUF) for outputting a value unique to a device by using a physical feature of being difficult to copy. Because of a characteristic of being difficult to copy, such a value unique to a device generated by using a PUF is expected to be used as, for example, an identifier (ID) for identifying each device or so-called key information (for example, a key for encryption).

### CITATION LIST

### Patent Document

Patent Document 1: Japanese Patent Application Laid-Open No. 2004-173154

### SUMMARY OF THE INVENTION

### Problems to be Solved by the Invention

In order to actually incorporate a PUF into a cryptographic system, it is necessary to execute processes of a conversion from a physical parameter to an analog electric signal and an analog-to-digital conversion. Then, in an event where information regarding the physical parameter leaks due to an attack from outside, a malicious attacker illegally acquires the PUF value of the device, and security is no longer ensured.

For this reason, the present disclosure proposes a new and improved control device and control method capable of minimizing side-channel leaks that can be generated before completion of an analog-to-digital conversion by a PUF implemented as a physical parameter and making attacks difficult.

### Solutions to Problems

The present disclosure provides a control device including a device unit that has regularly arranged analog devices, and a readout control unit that executes readouts that are a mixture of a first readout that generates unique information for the device unit and a second readout that does not generate unique information for the device.

Further, the present disclosure provides a control method including executing readouts that are a mixture of a first readout that generates unique information for a device unit that has regularly arranged analog devices and a second readout that does not generate unique information for the device.

### BRIEF DESCRIPTION OF DRAWINGS

FIG. 1 is a schematic configuration diagram illustrating an example of a configuration of a solid-state imaging device according to an embodiment of the present disclosure.

FIG. 2 is a diagram illustrating an outline of a configuration example of a stacked solid-state imaging device to which a technology according to the present disclosure can be applied.

FIG. 3 is a cross-sectional view illustrating a first configuration example of a stacked solid-state imaging device 23020.

FIG. 4 is a cross-sectional view illustrating a second configuration example of the stacked solid-state imaging device 23020.

FIG. 5 is a cross-sectional view illustrating a third configuration example of the stacked solid-state imaging device 23020.

FIG. 6 is a diagram illustrating another configuration example of a stacked solid-state imaging device to which the technology according to the present disclosure can be applied.

FIG. 7 is a block diagram illustrating an example of a functional configuration of a part of a solid-state imaging device according to the embodiment of the present disclosure.

FIG. 8 is a diagram illustrating an example of a circuit configuration of a unit pixel according to the embodiment of the present disclosure.

FIG. 9 is an explanatory diagram illustrating a working example of a PUF using a solid-state imaging device 1 according to the present embodiment.

FIG. 10 is an explanatory diagram illustrating specific examples of side-channel leaks that can occur during a period of time from when the PUF is read out to when an analog-to-digital conversion ends.

FIG. 11 is an explanatory diagram illustrating a dummy PUF readout executed by the solid-state imaging device 1 according to the embodiment of the present disclosure.

FIG. 12 is an explanatory diagram illustrating a dummy PUF readout executed by the solid-state imaging device 1 according to the embodiment of the present disclosure.

FIG. 13 is an explanatory diagram illustrating a specific form of a function f implemented by the solid-state imaging device 1 according to the embodiment of the present disclosure.

FIG. 14 is an explanatory diagram illustrating a setting example of a readout executed by execution of the function f by the solid-state imaging device 1 according to the embodiment of the present disclosure.

FIG. 15 is an explanatory diagram illustrating a functional configuration example of the solid-state imaging device 1 according to the embodiment of the present disclosure.

FIG. 16 is a flowchart illustrating an operation example of the solid-state imaging device 1 according to the embodiment of the present disclosure.

FIG. 17 is an explanatory diagram illustrating a modified example of a dummy PUF readout executed by the solid-state imaging device 1 according to the embodiment of the present disclosure.

FIG. 18 is an explanatory diagram illustrating a modified example of a dummy PUF readout executed by the solid-state imaging device 1 according to the embodiment of the present disclosure.

FIG. 19 is an explanatory diagram illustrating a modified example of a dummy PUF readout executed by the solid-state imaging device 1 according to the embodiment of the present disclosure.

### MODE FOR CARRYING OUT THE INVENTION

A preferred embodiment of the present disclosure will be described below in detail with reference to the accompanying drawings. Note that, in the present specification and drawings, components having substantially the same functional configurations are denoted by the same reference numerals, and the description thereof will thus not be repeated.

Note that the description will be given in the following order.

1. Embodiment of Present Disclosure

1.1. Background

1.2. Configuration Example

1.3. Operation Example

1.4. Modified Example

2. Summary

### 1. Embodiment of Present Disclosure

[1.1. Background]

First, a description will be given of a background that has led the discloser of the present application to the embodiment of the present disclosure.

As described above, attention has been paid to the technology called a PUF for outputting a value unique to a device by using a physical feature of being difficult to copy. Secret information of a PUF is statically stored in the device as a physical parameter of some kind. In order to actually incorporate a PUF into a cryptographic system, it is necessary to execute processes of a conversion from a physical parameter to an analog electric signal and an analog-to-digital conversion. These two processes are hereinafter collectively referred to as a “readout”.

Physical parameters themselves are at very low risk of side-channel leakages, which is a strength of the PUF. However, it cannot be said that there is no vulnerability to side-channel leakages that occur during a readout or an analog-to-digital conversion. Especially in a case where the embodiment of the PUF is a sensor, such as an image sensor, having a regular array pattern and a regular arrangement of analog-to-digital converters, a signal path through which the secret information is transmitted is often obvious, and this may lead to a vulnerability to side-channel attacks such as electromagnetic field analysis. Any physical phenomenon that can occur at the time of a readout, such as electromagnetic waves, an electric current, or light emission, will be hereinafter referred to as a side-channel leak.

On the other hand, countermeasures against side-channel attacks related to signal processing after an analog-to-digital conversion are already widely known. Such countermeasures against side-channel attacks related to signal processing after an analog-to-digital conversion include, for example, a well-known countermeasure against a differential power analysis (DPA) attack on an advanced encryption standard (AES) encryption circuit. However, this technology is limited to only after the end of an analog-to-digital conversion, and is not a countermeasure against side-channel attacks in a path before the end of a conversion from a physical parameter to an analog electric signal and an analog-to-digital conversion.

For this reason, in view of the above points, the discloser of the present application has worked earnestly on a technology capable of minimizing side-channel leaks that can be generated before completion of an analog-to-digital conversion by the PUF implemented as a physical parameter, thereby making it difficult for an attacker to attack. As a result, as described below, the discloser of the present application has successfully devised a technology capable of minimizing side-channel leaks that can be generated before completion of an analog-to-digital conversion by the PUF implemented as a physical parameter, thereby making it difficult for an attacker to attack.

The background that has led to the embodiment of the present disclosure has been described above. Next, the embodiment of the present disclosure will be described in detail.

[1.2. Configuration example]

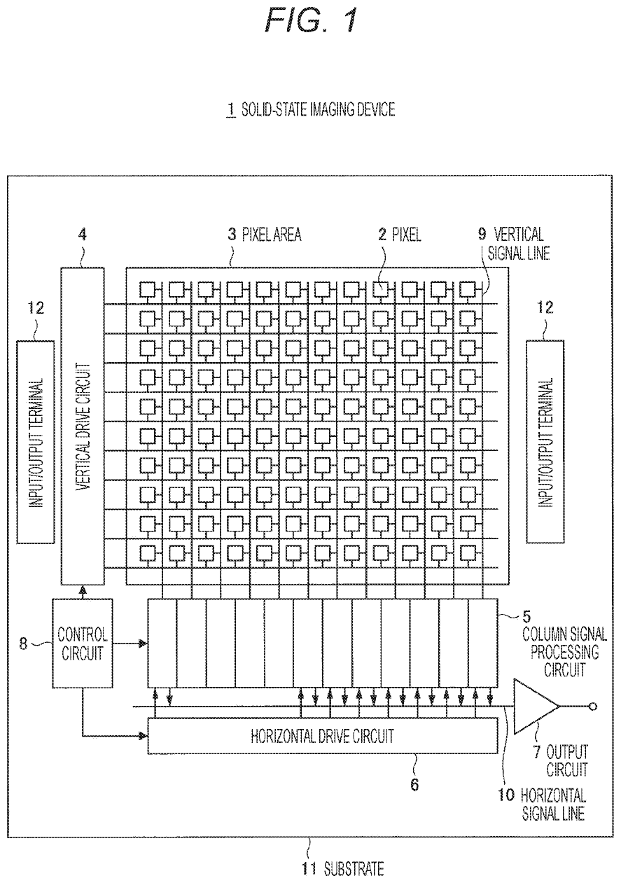

FIG. 1 illustrates a schematic configuration of a CMOS solid-state imaging device as an example of a configuration of a solid-state imaging device according to the embodiment of the present disclosure. This CMOS solid-state imaging device is applied to the solid-state imaging device of each embodiment. As illustrated in FIG. 1, a solid-state imaging device 1 in this example is constituted by a semiconductor substrate 11, a pixel array (so-called pixel area) 3 in which pixels 2 including a plurality of photoelectric conversion units are regularly arrayed in a two-dimensional array on, for example, a silicon substrate, and a peripheral circuit unit. The pixels 2 include, for example, photodiodes serving as photoelectric conversion units and a plurality of pixel transistors (so-called MOS transistors). The plurality of pixel transistors can be constituted by three transistors, for example, a transfer transistor, a reset transistor, and an amplification transistor. Alternatively, the plurality of pixel transistors can be configured by four transistors by adding a selection transistor. Note that an example of an equivalent circuit of a unit pixel will be described later separately. The pixels 2 can be configured as one unit pixel. Furthermore, the pixels 2 may have a shared pixel structure. The shared pixel structure is constituted by a plurality of photodiodes, a plurality of transfer transistors, one shared floating diffusion, and one shared pixel transistor of each of other types. That is, the shared pixels have a configuration in which the photodiodes and the transfer transistors that constitute a plurality of unit pixels share one pixel transistor of each of other types.

The peripheral circuit unit is constituted by a vertical drive circuit 4, column signal processing circuits 5, a horizontal drive circuit 6, an output circuit 7, a control circuit 8, and the like.

The control circuit 8 receives an input clock and data instructing an operation mode and the like, and outputs data such as internal information of the solid-state imaging device. That is, on the basis of a vertical synchronization signal, a horizontal synchronization signal, and a master clock, the control circuit 8 generates a clock signal and a control signal that serve as the basis of operations of the vertical drive circuit 4, the column signal processing circuits 5, the horizontal drive circuit 6, and the like. Then, these signals are input to the vertical drive circuit 4, the column signal processing circuits 5, the horizontal drive circuit 6, and the like.

The vertical drive circuit 4 is constituted by, for example, a shift register, selects a pixel drive wiring, supplies a pulse for driving pixels to the selected pixel drive wiring, and drives the pixels on a row-by-row basis. That is, the vertical drive circuit 4 selectively scans each of the pixels 2 in the pixel array 3 on a row-by-row basis sequentially in a vertical direction, and supplies, through a vertical signal line 9 to the column signal processing circuits 5, a pixel signal based on signal charge generated in accordance with the amount of light received by a photodiode or the like serving as a photoelectric conversion unit of each of the pixels 2.

The column signal processing circuits 5 are arranged, for example, one for each of columns of the pixels 2, and perform signal processing such as noise removal for each pixel column on signals output from the pixels 2 in one row. That is, the column signal processing circuits 5 perform signal processing such as correlated double sampling for removing fixed pattern noise unique to the pixels 2, signal amplification, and an analog-to-digital conversion. Horizontal selection switches (not illustrated) are provided at output stages of the column signal processing circuits 5 and connected between the column signal processing circuits 5 and a horizontal signal line 10.

The horizontal drive circuit 6 is constituted by, for example, a shift register, sequentially outputs horizontal scanning pulses to sequentially select each of the column signal processing circuits 5, and causes each of the column signal processing circuits 5 to output a pixel signal to the horizontal signal line 10.

The output circuit 7 performs signal processing on signals sequentially supplied from each of the column signal processing circuits 5 through the horizontal signal line 10, and outputs the processed signals. For example, only buffering may be performed, or black level adjustment, column variation correction, various types of digital signal processing, and the like may be performed. An input/output terminal 12 is used to exchange signals with the outside.

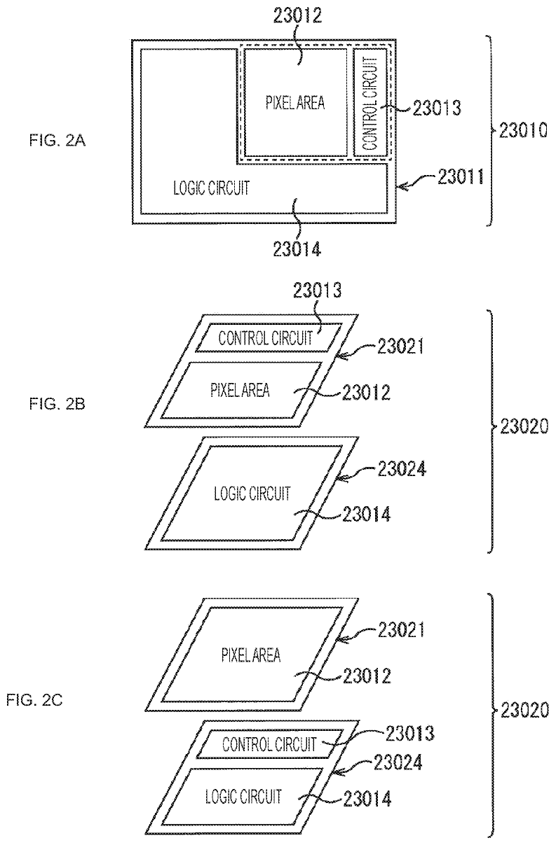

Furthermore, FIG. 2 is a diagram illustrating an outline of a configuration example of a stacked solid-state imaging device to which a technology according to the present disclosure can be applied.

A of FIG. 2 illustrates a schematic configuration example of a non-stacked solid-state imaging device. A solid-state imaging device 23010 has one die (semiconductor substrate) 23011 as illustrated in A of FIG. 2. The die 23011 includes a pixel area 23012 in which pixels are arranged in an array, a control circuit 23013 for driving the pixels and performing other various controls, and a logic circuit 23014 for signal processing.

B and C of FIG. 2 illustrate schematic configuration examples of the stacked solid-state imaging device. As illustrated in B and C of FIG. 2, a solid-state imaging device 23020 has a configuration as one semiconductor chip in which two dies, a sensor die 23021 and a logic die 23024, are stacked and electrically connected.

In B of FIG. 2, the sensor die 23021 includes the pixel area 23012 and the control circuit 23013, and the logic die 23024 includes the logic circuit 23014 including a signal processing circuit for performing signal processing.

In C of FIG. 2, the sensor die 23021 includes the pixel area 23012, and the logic die 23024 includes the control circuit 23013 and the logic circuit 23014.

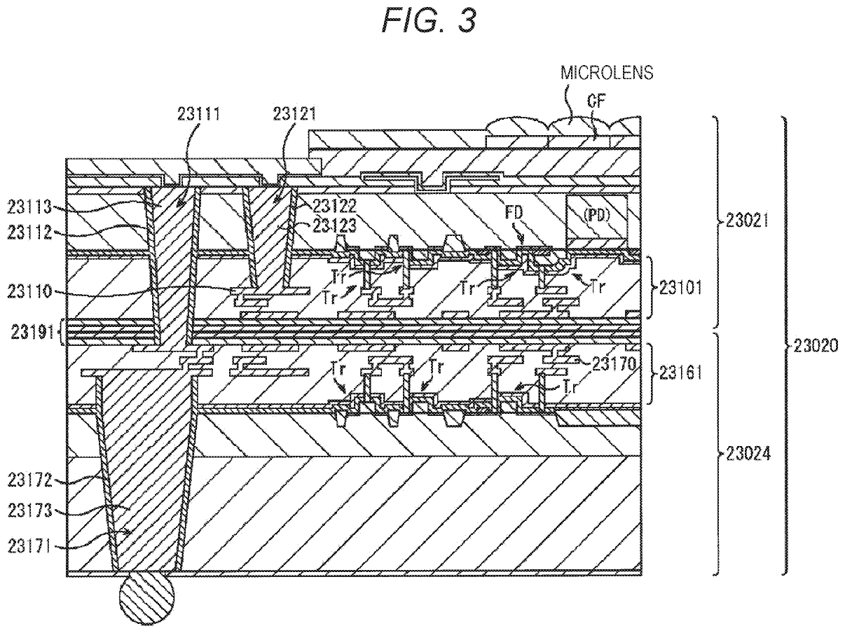

FIG. 3 is a cross-sectional view illustrating a first configuration example of the stacked solid-state imaging device 23020.

A photodiode (PD) constituting pixels serving as the pixel area 23012, a floating diffusion (FD), a metal-oxide-semiconductor field-effect transistor (Tr), a Tr serving as the control circuit 23013, and the like are formed on the sensor die 23021. Moreover, on the sensor die 23021, a wiring layer 23101 having a multi-layer, or three-layer in this example, wiring 23110 is formed. Note that the control circuit 23013 (Tr) may be included in a configuration of the logic die 23024, not of the sensor die 23021.

On the logic die 23024, a Tr constituting the logic circuit 23014 is formed. Moreover, on the logic die 23024, a wiring layer 23161 having a multi-layer, or three-layer in this example, wiring 23170 is formed. Furthermore, in the logic die 23024, a connection hole 23171 having an insulating film 23172 formed on an inner wall surface is formed, and a connection conductor 23173 connected to the wiring 23170 and the like is embedded in the connection hole 23171.

The sensor die 23021 and the logic die 23024 are bonded together so that their wiring layers 23101 and 23161 face each other, and thus the stacked solid-state imaging device 23020 has a configuration in which the sensor die 23021 and the logic die 23024 are stacked. A film 23191 such as a protective film is formed on faces via which the sensor die 23021 and the logic die 23024 are bonded together.

The sensor die 23021 has a connection hole 23111 formed so as to penetrate the sensor die 23021 from the back side (the side through which light enters the PD) (upper side) of the sensor die 23021 and reach the wiring 23170 in an uppermost layer of the logic die 23024. Moreover, the sensor die 23021 has a connection hole 23121 formed, in the vicinity of the connection hole 23111, from the back side of the sensor die 23021 to the wiring 23110 in a first layer. An insulating film 23112 is formed on an inner wall surface of the connection hole 23111, and an insulating film 23122 is formed on an inner wall surface of the connection hole 23121. Then, connection conductors 23113 and 23123 are embedded in the connection holes 23111 and 23121, respectively. The connection conductor 23113 and the connection conductor 23123 are electrically connected on the back side of the sensor die 23021, and the sensor die 23021 and the logic die 23024 are thus electrically connected via the wiring layer 23101, the connection hole 23121, the connection hole 23111, and the wiring layer 23161.

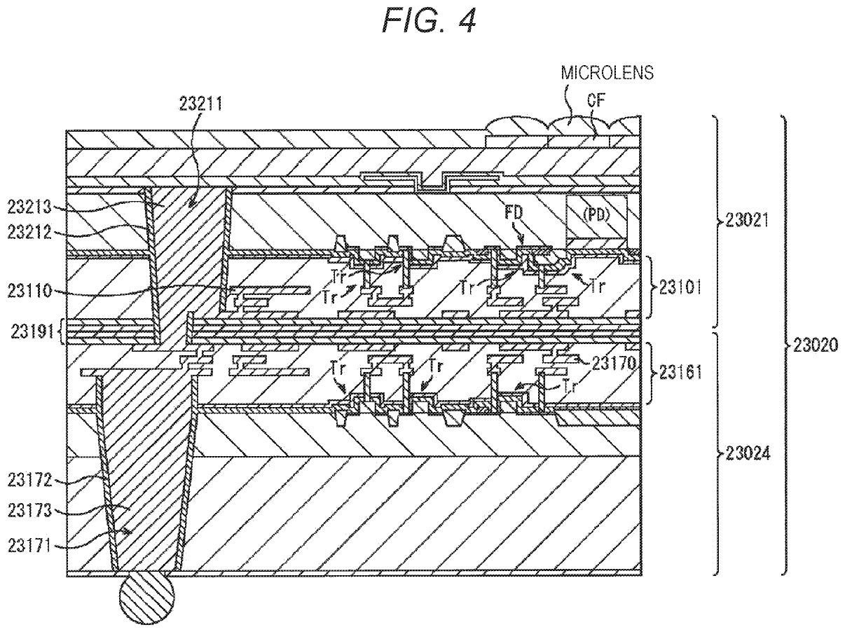

FIG. 4 is a cross-sectional view illustrating a second configuration example of the stacked solid-state imaging device 23020.

In the second configuration example of the solid-state imaging device 23020, one connection hole 23211 is formed in the sensor die 23021 to electrically connect the sensor die 23021 (the wiring layer 23101 (the wiring 23110)) and the logic die 23024 (the wiring layer 23161 (the wiring 23170)).

That is, in FIG. 4, the connection hole 23211 is formed so as to penetrate the sensor die 23021 from the back side of the sensor die 23021 and reach the wiring 23170 in an uppermost layer of the logic die 23024, and also reach the wiring 23110 in an uppermost layer of the sensor die 23021. An insulating film 23212 is formed on an inner wall surface of the connection hole 23211, and a connection conductor 23213 is embedded in the connection hole 23211. In FIG. 3 described above, the sensor die 23021 and the logic die 23024 are electrically connected by the two connection holes 23111 and 23121. In FIG. 4, the sensor die 23021 and the logic die 23024 are electrically connected by one connection hole 23211.

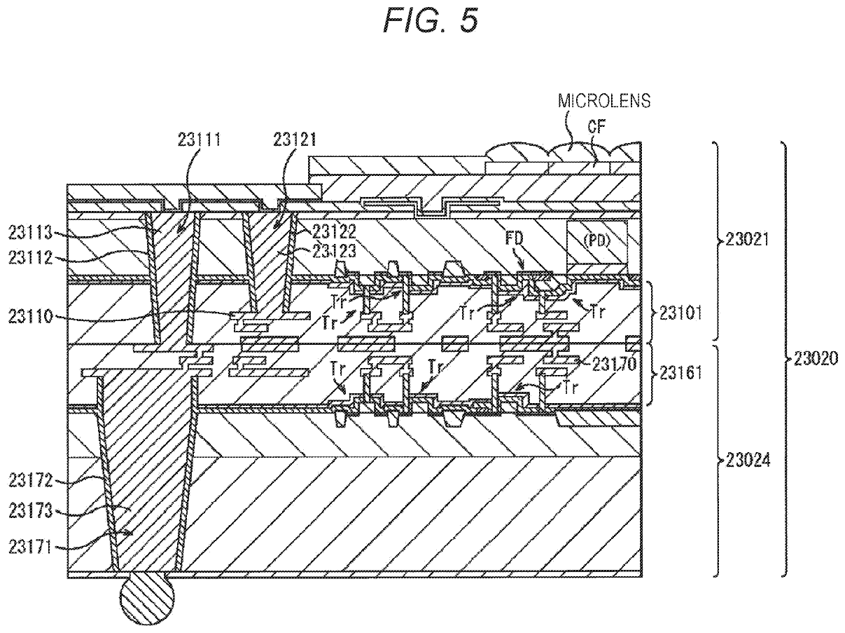

FIG. 5 is a cross-sectional view illustrating a third configuration example of the stacked solid-state imaging device 23020.

The solid-state imaging device 23020 in FIG. 5 does not have the film 23191 such as a protective film formed on the faces via which the sensor die 23021 and the logic die 23024 are bonded together, which is the difference from the case of FIG. 3 in which the film 23191 such as a protective film is formed on the faces via which the sensor die 23021 and the logic die 23024 are bonded together.

The solid-state imaging device 23020 in FIG. 5 has a configuration in which the wirings 23110 and 23170 are directly bonded together by overlapping the sensor die 23021 and the logic die 23024 so that the wirings 23110 and 23170 are in direct contact with each other and heating the sensor die 23021 and the logic die 23024 with a predetermined weight applied.

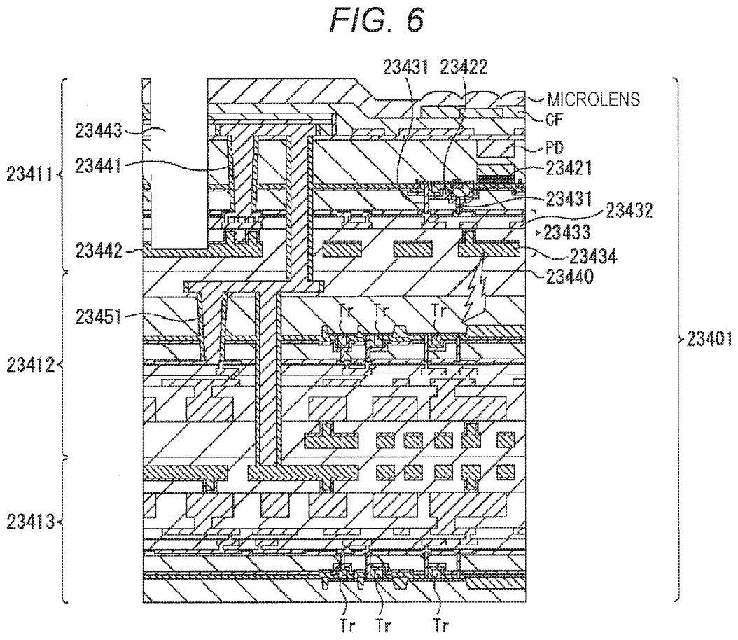

FIG. 6 is a cross-sectional view illustrating another configuration example of a stacked solid-state imaging device to which the technology according to the present disclosure can be applied.

In FIG. 6, a solid-state imaging device 23401 has a three-layer stacked structure in which three dies, a sensor die 23411, a logic die 23412, and a memory die 23413 are stacked.

The memory die 23413 includes, for example, a memory circuit that stores data temporarily required in signal processing performed by the logic die 23412.

In FIG. 6, the logic die 23412 and the memory die 23413 are stacked in that order under the sensor die 23411, but the logic die 23412 and the memory die 23413 can be stacked in the reverse order, that is, in the order of the memory die 23413 and the logic die 23412 under the sensor die 23411.

Note that, in FIG. 6, a PD serving as a photoelectric conversion unit of pixels and source/drain regions of a pixel Tr are formed in the sensor die 23411.

A gate electrode is formed around the PD with a gate insulating film interposed therebetween, and a pixel Tr 23421 and a pixel Tr 23422 are formed by the gate electrode and the paired source/drain regions.

The pixel Tr 23421 adjacent to the PD serves as a transfer Tr, and one of the paired source/drain regions constituting the pixel Tr 23421 serves as an FD.

Furthermore, an interlayer insulating film is formed in the sensor die 23411, and a connection hole is formed in the interlayer insulating film. In the connection hole, a connection conductor 23431 connected to the pixel Tr 23421 and the pixel Tr 23422 is formed.

Moreover, a wiring layer 23433 having a multi-layer wiring 23432 connected to each connection conductor 23431 is formed in the sensor die 23411.

Furthermore, an aluminum pad 23434 serving as an electrode for external connection is formed in the lowermost layer of the wiring layer 23433 of the sensor die 23411. That is, in the sensor die 23411, the aluminum pad 23434 is formed at a position closer to a surface 23440 joined to the logic die 23412 than to the wiring 23432. The aluminum pad 23434 is used as one end of a wiring related to input/output of a signal with the outside.

Moreover, a contact 23441 used for electrical connection with the logic die 23412 is formed in the sensor die 23411. The contact 23441 is connected to a contact 23451 of the logic die 23412 and also to an aluminum pad 23442 of the sensor die 23411.

Then, the sensor die 23411 has a pad hole 23443 that is formed from the back side (upper side) of the sensor die 23411 and reaches the aluminum pad 23442.

The technology according to the present disclosure can be applied to the solid-state imaging device as described above.

Note that, in the examples described with reference to FIGS. 3 to 6, for example, copper (Cu) wirings are used for various wirings. Furthermore, a configuration in which wirings (for example, the wirings 23110 and 23170 illustrated in FIG. 5) are directly bonded between sensor dies stacked one on the other as illustrated in FIG. 5 is hereinafter referred to also as “Cu—Cu bonding”.

<1.2. Functional configuration>

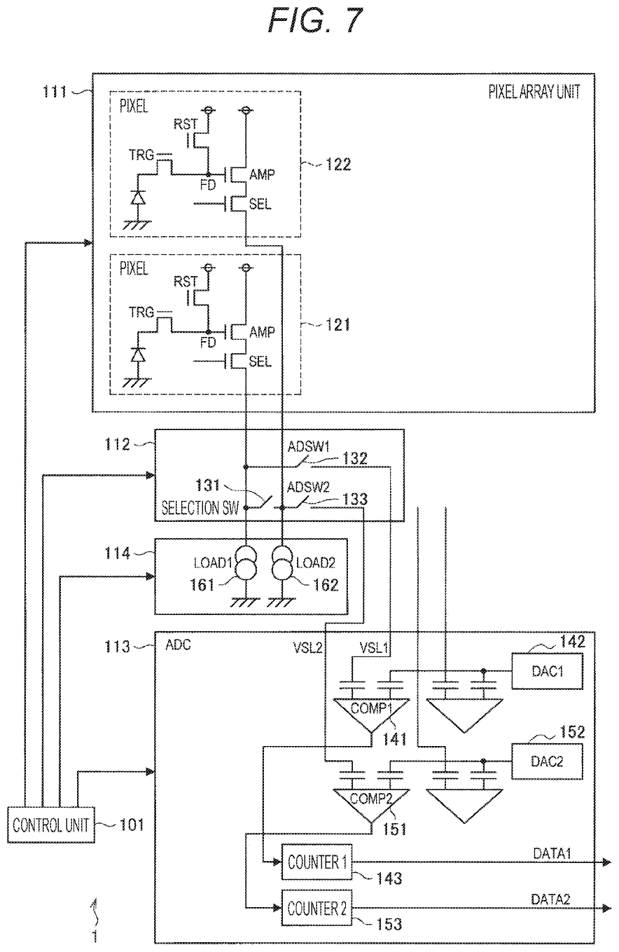

Next, an example of a functional configuration of the solid-state imaging device according to the embodiment of the present disclosure will be described with reference to FIG. 7. FIG. 7 is a block diagram illustrating an example of a functional configuration of a part of the solid-state imaging device according to the embodiment of the present disclosure. The solid-state imaging device 1 illustrated in FIG. 7 is an imaging element, such as, for example, a complementary metal oxide semiconductor (CMOS) image sensor or a charge coupled device (CCD) image sensor, that captures an image of a subject and obtains digital data of the captured image.

As illustrated in FIG. 7, the solid-state imaging device 1 includes a control unit 101, a pixel array unit 111, a selection unit 112, an analog digital converter (ADC) 113, and a constant current circuit unit 114.

The control unit 101 controls each unit of the solid-state imaging device 1 to execute processing related to readout of image data (pixel signals) and the like.

The pixel array unit 111 is a pixel area in which pixel configurations having photoelectric conversion elements such as photodiodes are arranged in a matrix (array). The pixel array unit 111 is controlled by the control unit 101 to receive light from a subject at each pixel, photoelectrically convert the incident light, accumulate electric charge, and output the electric charge accumulated at each pixel at a predetermined timing as a pixel signal.

A pixel 121 and a pixel 122 represent two vertically adjacent pixels in a pixel group arranged in the pixel array unit 111. The pixel 121 and the pixel 122 are in consecutive rows in the same column. In the example of FIG. 7, as illustrated in the pixel 121 and the pixel 122, a photoelectric conversion element and four transistors are used for a circuit of each pixel. Note that the circuit of each pixel may have any configuration other than the example illustrated in FIG. 7.

In a general pixel array, an output line for a pixel signal is provided for each column. In the case of the pixel array unit 111, two (two system) output lines are provided for each column (column). Circuits of pixels in one column are alternately connected to these two output lines every other row. For example, circuits of pixels in odd-numbered rows from the top are connected to one output line, and circuits of pixels in even-numbered rows are connected to the other output line. In the example of FIG. 7, the circuit of the pixel 121 is connected to a first output line (VSL 1), and the circuit of the pixel 122 is connected to a second output line (VSL 2).

Note that although FIG. 7 illustrates only one column of output lines for convenience of description, in practice, two output lines are similarly provided for each column. Each output line is connected with circuits of pixels in that column every other row.

The selection unit 112 has a switch for connecting each output line of the pixel array unit 111 to an input of the ADC 113, and is controlled by the control unit 101 to control a connection between the pixel array unit 111 and the ADC 113. That is, a pixel signal read out from the pixel array unit 111 is supplied to the ADC 113 via the selection unit 112.

The selection unit 112 has a switch 131, a switch 132, and a switch 133. The switch 131 (selection SW) controls a connection between two output lines corresponding to the same column. For example, the first output line (VSL 1) and the second output line (VSL 2) are connected when the switch 131 is turned on, and are disconnected when the switch 131 is turned off.

As described later in detail, the solid-state imaging device 1 is provided with one ADC for each output line (column ADC). Thus, assuming that both the switch 132 and the switch 133 are on, turning on the switch 131 connects the two output lines of the same column, thereby causing a circuit of one pixel to be connected to two ADCs. Conversely, turning off the switch 131 disconnects the two output lines of the same column, thereby causing a circuit of one pixel to be connected to one ADC. That is, the switch 131 selects the number of ADCs (column ADCs) to which signals from one pixel are output.

As described later in detail, the switch 131 controls the number of ADCs to which pixel signals are output as described above, and this allows the solid-state imaging device 1 to output a wider variety of pixel signals in accordance with the number of the ADCs. That is, the solid-state imaging device 1 can output a wider variety of data.

The switch 132 controls a connection between the first output line (VSL 1) corresponding to the pixel 121 and an ADC corresponding to the output line. When the switch 132 is turned on, the first output line is connected to an input of one of comparators of the corresponding ADC. Furthermore, when the switch is turned off, they are disconnected.

The switch 133 controls a connection between the second output line (VSL 2) corresponding to the pixel 122 and an ADC corresponding to the output line. When the switch 133 is turned on, the second output line is connected to an input of one of comparators of the corresponding ADC. Furthermore, when the switch is turned off, they are disconnected.

The selection unit 112 can control the number of ADCs (column ADCs) to which signals from one pixel are output by switching between such states of the switches 131 to 133 under the control of the control unit 101.

Note that the switch 132 and the switch 133 (either one or both of them) may be omitted, and each output line may be always connected to an ADC corresponding to the output line. However, allowing these switches to control connection/disconnection between them expands the range of selection of the number of ADCs (column ADCs) to which one pixel outputs signals. That is, providing these switches allows the solid-state imaging device 1 to output a wider variety of pixel signals.

Note that, although FIG. 7 illustrates only the configuration for the output lines of one column, in practice, the selection unit 112 has, for each column, a configuration similar to that illustrated in FIG. 7 (the switches 131 to 133). That is, the selection unit 112 performs a connection control similar to that described above for each column under the control of the control unit 101.

The ADC 113 performs an analog-to-digital conversion on each of pixel signals supplied from the pixel array unit 111 via each output line, and then outputs the pixel signals as digital data. The ADC 113 has an ADC (column ADC) for each output line from the pixel array unit 111. That is, the ADC 113 has a plurality of column ADCs. A column ADC corresponding to one output line is a single-slope ADC having a comparator, a digital-to-analog converter (DAC), and a counter.

The comparator compares the DAC output with a signal value of a pixel signal. The counter increments its count value (digital value) until the pixel signal and the DAC output become equal. The comparator stops the counter when the DAC output reaches the signal value. Thereafter, signals digitized by counters 1 and 2 are output to the outside of the solid-state imaging device 1 from DATA 1 and DATA 2.

After outputting the data for the following analog-to-digital conversion, the counters change their count values back to an initial value (for example, 0).

The ADC 113 has two system column ADCs for each column. For example, a comparator 141 (COMP 1), a DAC 142 (DAC 1), and a counter 143 (counter 1) are provided for the first output line (VSL 1), and a comparator 151 (COMP 2), a DAC 152 (DAC 2), and a counter 153 (counter 2) are provided for the second output line (VSL 2). Although not illustrated, the ADC 113 has a similar configuration for output lines of other columns.

However, among these configurations, the DACs can be provided in the form of a shared DAC. Such a shared DAC is provided on a system-by-system basis. That is, DACs for the same system in the columns are provided in the form of a shared DAC. In the example of FIG. 7, DACs corresponding to the first output lines (VSL 1) of the columns are provided in the form of the shared DAC 142, and DACs corresponding to the second output lines (VSL 2) of the columns are provided in the form of the shared DAC 152. Note that a comparator and a counter are provided for each system of each output line.

The constant current circuit unit 114 is a constant current circuit connected to each output line, and is controlled and driven by the control unit 101. The circuit of the constant current circuit unit 114 is constituted by, for example, a metal oxide semiconductor (MOS) transistor and the like. Although this circuit configuration is optional, in FIG. 7, for convenience of description, the first output line (VSL 1) is provided with a MOS transistor 161 (LOAD 1), and the second output line (VSL 2) is provided with a MOS transistor 162 (LOAD 2).

For example, the control unit 101 receives a request from the outside such as a user, selects a readout mode, and controls the selection unit 112 to control a connection to an output line. Furthermore, the control unit 101 controls driving of a column ADC in accordance with the selected readout mode. Moreover, besides the driving of the column ADC, the control unit 101 controls driving of the constant current circuit unit 114 as necessary, and controls driving of the pixel array unit 111 such as a rate and timing of a readout, for example.

That is, the control unit 101 can not only control the selection unit 112 but also cause each unit other than the selection unit 112 to operate in a wider variety of modes. Thus, the solid-state imaging device 1 can output a wider variety of pixel signals.

Note that the number of pieces of each unit illustrated in FIG. 7 may be any number as long as the number is not insufficient. For example, output lines of three or more systems may be provided for each column. Furthermore, the number of parallel pixel signals output from the ADC 132 or the number of ADCs 132 themselves illustrated in FIG. 7 may be increased to increase the number of pixel signals output in parallel to the outside.

The example of the functional configuration of the solid-state imaging device according to the embodiment of the present disclosure has been described above with reference to FIG. 7.

<1.3. Circuit configuration of unit pixel>

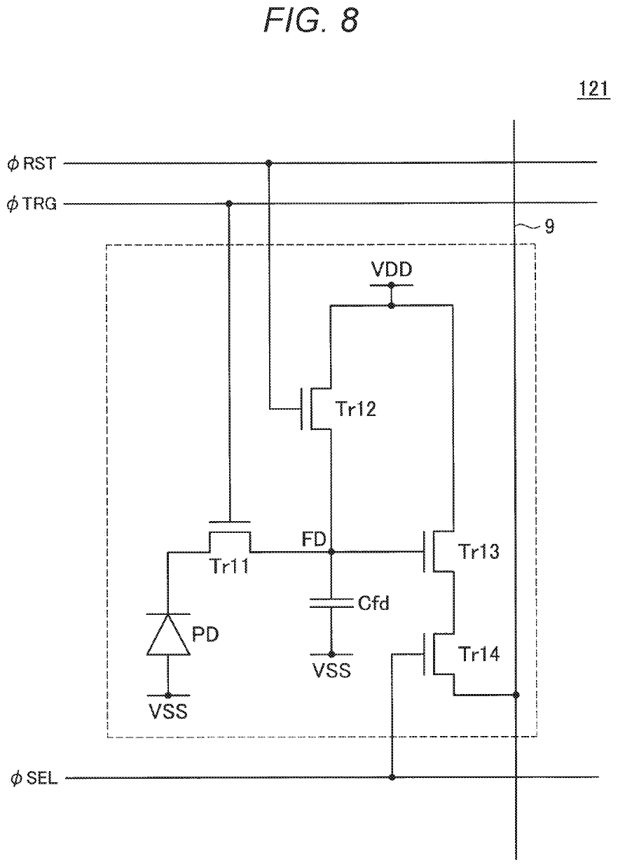

Next, an example of a circuit configuration of a unit pixel will be described with reference to FIG. 8. FIG. 8 is a diagram illustrating an example of a circuit configuration of a unit pixel according to the embodiment of the present disclosure. As illustrated in FIG. 8, the unit pixel 121 according to the embodiment of the present disclosure includes a photoelectric conversion unit, for example, a photodiode PD, and four pixel transistors. The four pixel transistors are, for example, a transfer transistor Tr11, a reset transistor Tr12, an amplification transistor Tr13, and a selection transistor Tr14. These pixel transistors can be constituted by, for example, re-channel MOS transistors.

The transfer transistor Tr11 is connected between the cathode of the photodiode PD and a floating diffusion unit FD. Signal charge (here, electrons) that has been photoelectrically converted by the photodiode PD and accumulated here is transferred to the floating diffusion unit FD by applying a transfer pulse φTRG to a gate. Note that a reference numeral Cfd schematically indicates a parasitic capacitance of the floating diffusion unit FD.

The reset transistor Tr12 has a drain connected to a power supply VDD and a source connected to the floating diffusion unit FD. Then, prior to transfer of the signal charge from the photodiode PD to the floating diffusion unit FD, a reset pulse φRST is applied to the gate to reset a potential of the floating diffusion unit FD.

The amplification transistor Tr13 has a gate connected to the floating diffusion unit FD, a drain connected to the power supply VDD, and a source connected to a drain of the selection transistor Tr14. The amplification transistor Tr13 outputs, to the selection transistor Tr14, a potential of the floating diffusion unit FD after being reset by the reset transistor Tr12, as a reset level. Moreover, the amplification transistor Tr13 outputs, to the selection transistor Tr14, a potential of the floating diffusion unit FD after the transfer of the signal charge by the transfer transistor Tr11, as a signal level.

The selection transistor Tr14 has, for example, the drain connected to the source of the amplification transistor Tr13, and a source connected to the vertical signal line 9. Then, when a selection pulse φSEL is applied to a gate of the selection transistor Tr14, the selection transistor Tr14 is turned on, and a signal output from the amplification transistor Tr13 is output to the vertical signal line 9. Note that it is possible to adopt a configuration in which the selection transistor Tr14 is connected between the power supply VDD and the drain of the amplification transistor Tr13.

Note that, in a case where the solid-state imaging device 1 according to the present embodiment is configured as a stacked solid-state imaging device, for example, elements such as a photodiode and a plurality of MOS transistors are formed in the sensor die 23021 in B or C of FIG. 2. Furthermore, the transfer pulse, the reset pulse, the selection pulse, and the power supply voltage are supplied from the logic die 23024 in B or C of FIG. 2. Furthermore, an element at a stage subsequent to the vertical signal line 9 connected to a drain of a selection transistor is, an element at a stage subsequent to the vertical signal line 9 connected to a drain of a selection transistor is included in a configuration of the logic circuit 23014, and is formed in the logic die 23024.

The example of the circuit configuration of the unit pixel has been described above with reference to FIG. 8.

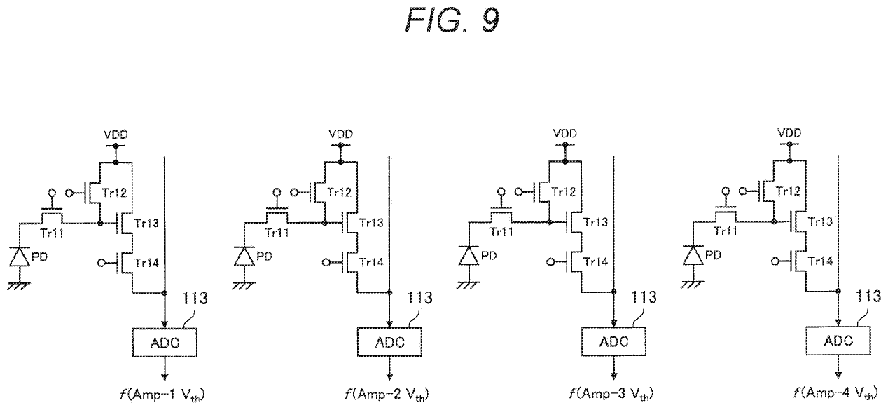

FIG. 9 is an explanatory diagram illustrating a working example of a PUF using the solid-state imaging device 1 according to the present embodiment. This PUF uses a voltage value (voltage threshold) of an amplification transistor (the amplification transistor Tr13 illustrated in FIG. 8) as a physical parameter. Then, by raising an input of a reset transistor (the reset transistor Tr14 illustrated in FIG. 8) and a selection transistor (the selection transistor Tr12 illustrated in FIG. 8) to High, an analog signal correlated with variation in voltage threshold of an amplification transistor flows through the vertical signal line 9 and is input to the ADC 113. A digitized value after an analog-to-digital conversion by the ADC 113 (hereinafter referred to as a PUF value) is used in a secure domain of a digital system as a key value for generation or encryption of a unique ID for each device, which is a normal usage of PUFs.

FIG. 9 illustrates four unit pixels in a horizontal direction. Furthermore, FIG. 9 illustrates a state in which a PUF value f(Amp-1 Vth) to f(Amp-4 Vth) is generated from an analog signal correlated with variation in voltage threshold (Amp-1 Vth to Amp-4 Vth) of an amplification transistor provided for each unit pixel.

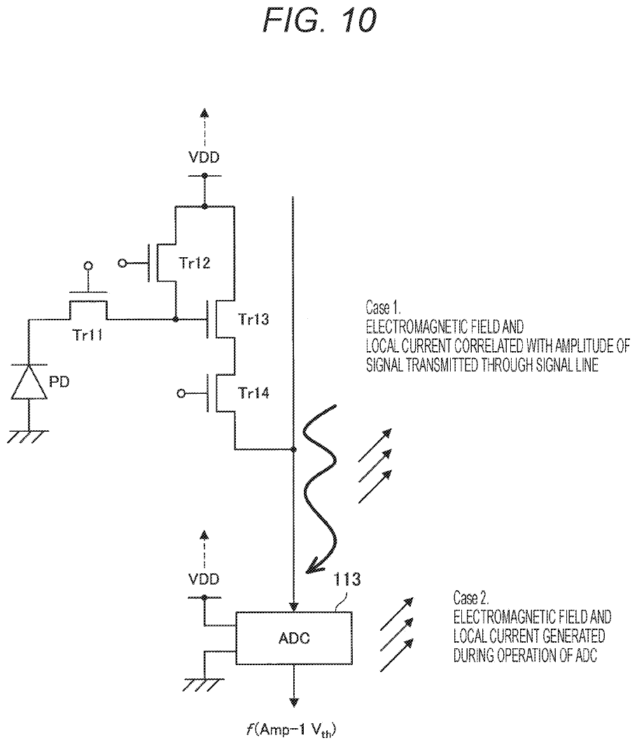

FIG. 10 is an explanatory diagram illustrating specific examples of side-channel leaks that can occur during a period of time from when the PUF is read out to when an analog-to-digital conversion ends. A first probable example of side-channel leaks may be an electromagnetic field flowing through a signal line. It is expected that there is a correlation between an amplitude of the electromagnetic field and a voltage threshold of an amplification transistor. A second probable example of side-channel leaks may be an electromagnetic field generated during operation of an analog-to-digital conversion. It is assumed that a time-series pattern of the electromagnetic field has a correlation with variation in voltage threshold of the amplification transistor. For example, in a case of a single-slope analog-to-digital conversion method, there is a correlation between an inversion timing of a comparator and a PUF value. Thus, in principle, it is possible for an attacker to estimate the PUF value by acquiring the inversion timing of the comparator from a side-channel leak such as an electromagnetic field generated from around the comparator.

For this reason, in order to make it extremely difficult for an attacker to estimate the PUF value, the solid-state imaging device 1 according to the embodiment of the present disclosure sends, through a signal line, an electric signal that does not lead to estimation of the PUF value, and executes an analog-to-digital conversion. A readout for outputting an electric signal that does not lead to estimation of the PUF value is hereinafter referred to as a “dummy PUF readout”. As opposed to the dummy PUF readout, a readout for outputting an electric signal that leads to estimation of the PUF value is simply referred to as a “PUF readout” or a “real PUF readout”.

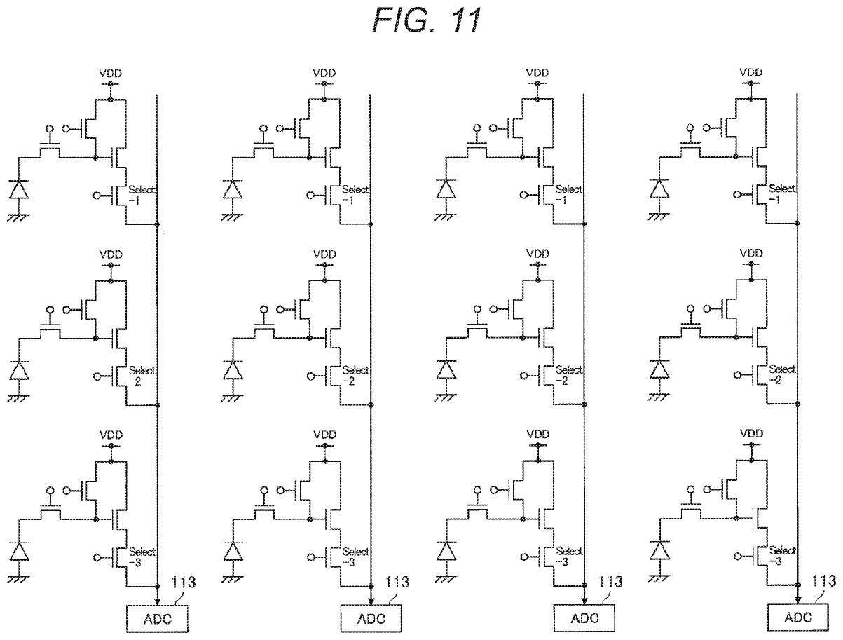

FIG. 11 is an explanatory diagram illustrating a dummy PUF readout executed by the solid-state imaging device 1 according to the embodiment of the present disclosure. It is assumed that an amplification transistor that can be specified by Select-1 is defined as a PUF. In this case, by executing a readout on an amplification transistor specified by Select-2 or Select-3 as a dummy PUF readout, since this amplification transistor is not the amplification transistor defined as a PUF, an electric signal that is a similar signal but does not lead to estimation of the PUF value can be sent through a signal line, and an analog-to-digital conversion can be executed.

This dummy PUF readout can be used aggressively to disturb attackers. Assuming that attackers cannot distinguish between a dummy PUF readout and a real PUF readout, attackers cannot obtain the PUF value even in a case where a side-channel leak has occurred at a measurable level. This assumption is considered to be valid for a variety of PUFs.

A dummy PUF readout executed by the solid-state imaging device 1 according to the embodiment of the present disclosure may be a readout such that a row different from the row adopted as the PUF is read out. Alternatively, in a case of an array type sensor such as an image sensor having an analog-to-digital conversion structure that is not constrained by row-by-row processing, the readout may be such that an area different from the area adopted as the PUF is read out.

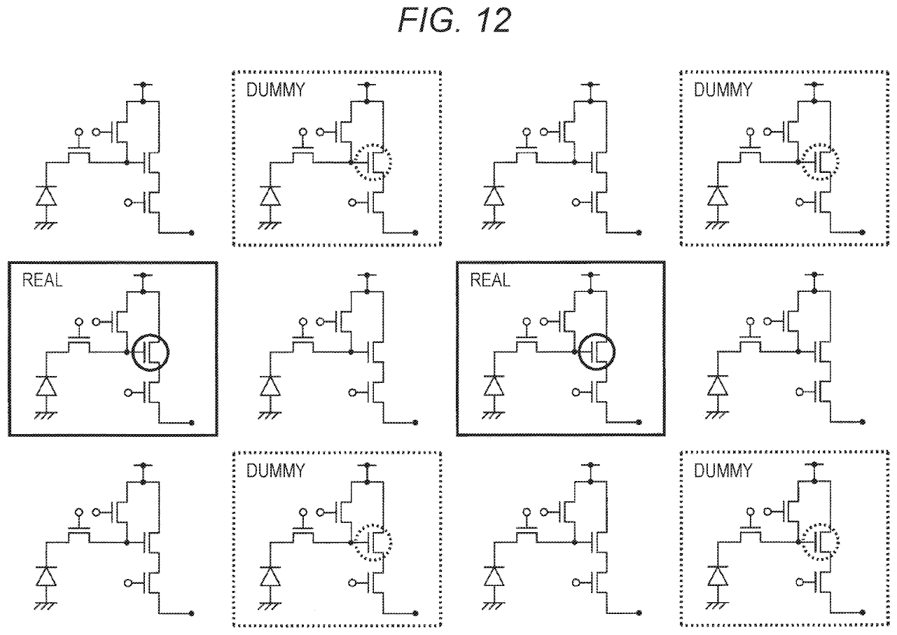

FIG. 12 is an explanatory diagram illustrating a dummy PUF readout executed by the solid-state imaging device 1 according to the embodiment of the present disclosure. In FIG. 12, it is assumed that the solid-state imaging device 1 has a structure that enables readout processing on a pixel-by-pixel basis. Furthermore, in FIG. 12, only a configuration of each pixel is illustrated, and output lines from each pixel are omitted. In the solid-state imaging device 1 according to the embodiment of the present disclosure, real PUF readouts may be performed on unit pixels indicated by solid lines, and dummy PUF readouts may be performed on unit pixels indicated by broken lines.

The solid-state imaging device 1 according to the embodiment of the present disclosure may execute an analog-to-digital conversion by performing an arithmetic operation between analog signals in a row or area adopted as a PUF and a row or area not adopted as a PUF. The arithmetic operation between the analog signals may include, for example, addition or subtraction in an analog domain.

Since dummy PUF readout methods depend on architectures, it is impossible to enumerate all the methods. However, the dummy PUF readout methods have a common point, that is, the methods can disturb attackers by reading out what has not been selected as secret information but is equivalent in type of physical parameter and generating a side-channel leak having a waveform similar to that of a real PUF readout.

Moreover, in a case where it is determined that a side-channel leak that occurs during operation of an analog-to-digital conversion is most useful from a viewpoint of an attacker, the solid-state imaging device 1 according to the embodiment of the present disclosure can execute, as a dummy PUF readout, a technique of changing and modulating a side-channel leak by changing an operation setting of an analog-to-digital converter, even in a case of a real PUF readout. Specifically, for example, there is a technique of changing and modulating a side-channel leak by using a technique of changing a dynamic range. This technique of changing an operation setting of an analog-to-digital converter indicates that it is not necessary to have a redundant circuit configuration for dummy PUF readouts.

However, in a case where a dummy readout is performed in the same pattern each time a system is started, an attacker may be able to distinguish between a dummy PUF readout and a real PUF readout by repeating startup and analyzing outputs.

For this reason, the solid-state imaging device 1 according to the embodiment of the present disclosure may change the method, pattern, and setting of a dummy PUF readout at each startup in order to make it more difficult to distinguish between a dummy PUF readout and a real PUF readout. The solid-state imaging device 1 according to the embodiment of the present disclosure may use random information that changes at each startup in order to change the method, pattern, and setting of a dummy PUF readout at each startup. As this random information, a random number generated by a random number generator having sufficient entropy can be used. By using random information to change the method, pattern, and setting (for example, the above-described operation setting of the analog-to-digital converter) of a dummy PUF readout at each startup, the solid-state imaging device 1 according to the embodiment of the present disclosure can make it extremely difficult for an attacker to guess a real PUF readout.

Specifically, the solid-state imaging device 1 according to the embodiment of the present disclosure implements the following function f. It does not matter whether the form of implementation is analog or digital, but outputs of f need to range widely enough to enable full use of the entropy of random numbers.

Dummy PUF readout pattern=f(random number)

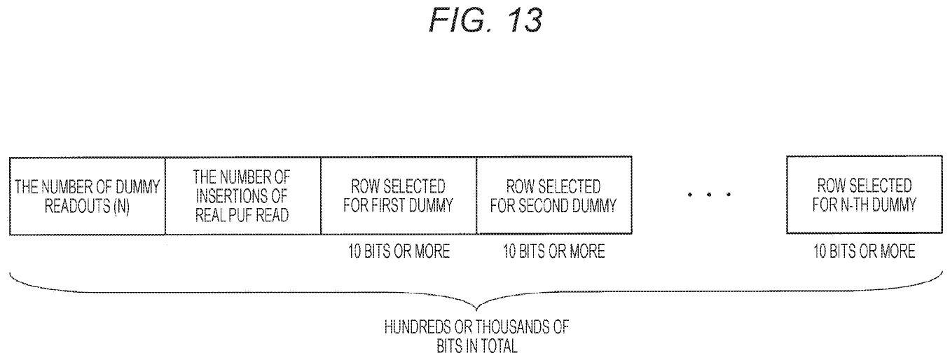

FIG. 13 is an explanatory diagram illustrating a specific form of the function f implemented by the solid-state imaging device 1 according to the embodiment of the present disclosure. The function f is designed so that, for example, each bit of a random number of about several hundred bits or more has a meaning as illustrated in FIG. 13, and the solid-state imaging device 1 interprets the meaning as such. The example illustrated in FIG. 13 means that, in a series of readouts including a real PUF readout and dummy PUF readouts, a real PUF readout is executed once, and a dummy PUF readout is executed N times, that is, a readout is executed N+1 times in total. Then, the timing at which the real PUF readout is executed and a row (or area) selected in each readout are also determined by a random number. Needless to say, the form of the function f illustrated in FIG. 13 is merely an example, and meaning to be given is dependent on the implementation. Being dependent on the implementation means that the meaning of the function f can be changed depending on, for example, whether or not the array can only be read out on a row-by-row basis, whether or not the array can be read out on a pixel-by-pixel basis or on an area-by-area basis, whether or not the implementation allows a setting of an analog-to-digital converter to be changed, or the like.

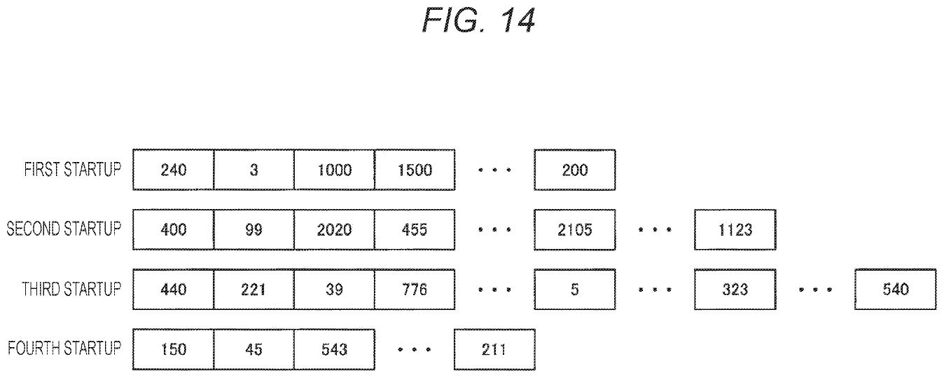

FIG. 14 is an explanatory diagram illustrating a setting example of a readout executed by execution of the function f by the solid-state imaging device 1 according to the embodiment of the present disclosure. FIG. 14 illustrates that the solid-state imaging device 1 executes a dummy PUF readout 240 times at a first startup and executes a real PUF readout at a third time. The solid-state imaging device 1 executes a dummy PUF readout 400 times at a second startup, and executes a real PUF readout at a 99th time. The solid-state imaging device 1 executes a dummy PUF readout 440 times at a third startup, and executes a real PUF readout at a 221st time. The solid-state imaging device 1 executes the dummy PUF readout 150 times at a fourth startup, and executes a real PUF readout at a 45th time.

As described above, the solid-state imaging device 1 according to the embodiment of the present disclosure can change, at each startup, a time-series pattern of side-channel leaks. Changing the time-series pattern of side-channel leaks makes it extremely difficult for an attacker to estimate at what point in time the side-channel leak corresponds to a real PUF readout. Then, the definition of the function f can be flexibly changed depending on the use of the solid-state imaging device 1. For example, increasing a bit depth allocated to the number of times of dummy PUF readout increases the difficulty for attacks. Reducing a bit depth allocated to the number of times of dummy PUF readout shortens the time required for a series of readouts. Thus, it is conceivable to increase the difficulty for attacks by increasing the bit depth allocated to the number of times of dummy PUF readout, or to make the time for readout shorter while maintaining a certain degree of difficulty for attacks by reducing the bit depth allocated to the number of times of dummy PUF readout.

In FIG. 13, the number of readouts and the readout timing are set as the form of the function f. However, the present disclosure is not limited to such an example, and a random number can be used also for an operation setting of an analog-to-digital converter.

The function f may be completely determined at the time of tape-out of the solid-state imaging device 1, or may have some flexibility by holding some parameters of the function f in a secure nonvolatile memory (for example, a storage unit 206 described later). By holding some parameters of the function f in the non-volatile memory in this way, a different function f can be executed for each device, and random numbers can be generated in different generation patterns.

The definition of “startup” in the present embodiment will be described. Normally, it is considered that readout of the PUF needs to be performed only once per power ON, so in most cases, “startup” means “system power ON”. On the other hand, PUF readout is performed a plurality of times per power ON in some cases. In this case, the difficulty for attacks can be increased by generating a new random number before readout.

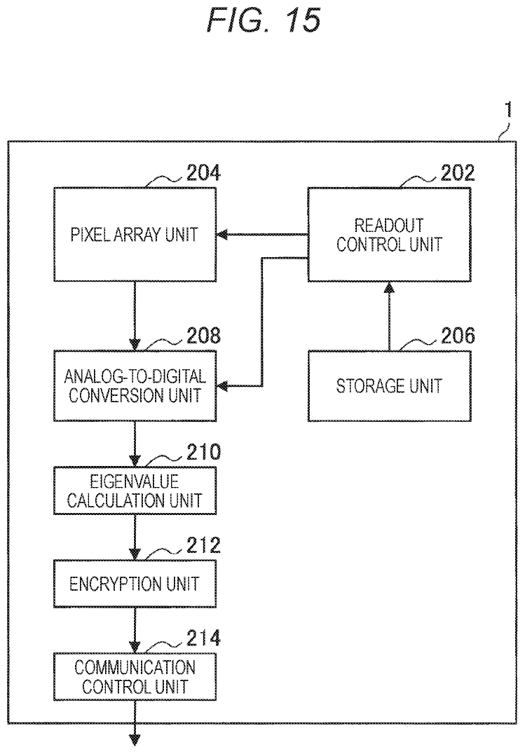

A functional configuration example of the solid-state imaging device 1 according to the embodiment of the present disclosure for executing the above-described operation will be described. FIG. 15 is an explanatory diagram illustrating a functional configuration example of the solid-state imaging device 1 according to the embodiment of the present disclosure.

As illustrated in FIG. 15, the solid-state imaging device 1 according to the embodiment of the present disclosure has a configuration including a readout control unit 202, a pixel array unit 204, the storage unit 206, an analog-to-digital conversion unit 208, an eigenvalue calculation unit 210, an encryption unit 212, and a communication control unit 214.

The readout control unit 202 generates a signal for driving the pixel array unit 204 described later on the basis of a predetermined input clock and data, thereby driving the pixel array unit 204. The readout control unit 202 can include, for example, the control circuit 8, the vertical drive circuit 4, and the horizontal drive circuit 6 in the configuration of the solid-state imaging device 1 described with reference to FIG. 1. Furthermore, the readout control unit 202 can be provided in the control circuit 23013 illustrated in FIG. 2.

As described above, the readout control unit 202 executes a real PUF readout and a dummy PUF readout. The readout control unit 202 executes the function f as described above when executing the real PUF readout and the dummy PUF readout.

The pixel array unit 204 has unit pixels arrayed in predetermined rows and columns, and is configured to output data by a source follower circuit. A circuit configuration of each pixel in the pixel array unit 204 is, for example, the one illustrated in FIG. 8. The pixel array unit 204 is driven by the readout control unit 202 and outputs an analog signal. The pixel array unit 204 can function as an example of an analog device of the present disclosure.

The storage unit 206 is constituted by a storage device that can store a variety of data and programs. For example, the storage unit 206 holds some parameters of a predetermined function f for generating a random number.

The analog-to-digital conversion unit 208 performs an analog-to-digital conversion on each pixel signal supplied from the pixel array unit 204 via each output line, and outputs the pixel signal as digital data. The analog-to-digital conversion unit 208 has an ADC (column ADC) for each output line from the pixel array unit 111. That is, the analog-to-digital conversion unit 208 has a plurality of column ADCs. A column ADC corresponding to one output line is a single-slope ADC having a comparator, a digital-to-analog converter (DAC), and a counter.

A setting of the analog-to-digital conversion unit 208 can be changed by the readout control unit 202 at the time of readout. By changing the setting of the analog-to-digital conversion unit 208 by the readout control unit 202, it is possible to make it difficult for an attacker to guess the PUF value. The pixel array unit 204 and the analog-to-digital conversion unit 208 can function as an example of device units of the present disclosure.

The eigenvalue calculation unit 210 calculates a value (PUF value) unique to the solid-state imaging device 1 on the basis of a digital signal sent from the analog-to-digital conversion unit 208. The eigenvalue calculation unit 210 generates a value having a predetermined bit length as a PUF value. After calculating the PUF value of the solid-state imaging device 1, the eigenvalue calculation unit 210 sends the eigenvalue to the encryption unit 212. The PUF value generated by the eigenvalue calculation unit 210 can serve as a seed or a key itself used in encryption processing in the encryption unit 212.

The method of calculating a PUF value is not limited to a specific method. For example, a PUF value may be calculated by combining, by any method, digital values obtained by analog-to-digital conversions. Alternatively, a PUF value may be calculated by performing arithmetic operations on digital values obtained by analog-to-digital conversions for a plurality of pixels, and then combining results of the arithmetic operations.

The encryption unit 212 uses the PUF value generated by the eigenvalue calculation unit 210 to execute data encryption processing. The encryption unit 212 can be provided in, for example, the logic circuit 23014 illustrated in FIG. 2. Specifically, the encryption unit 212 uses the PUF value generated by the eigenvalue calculation unit 210 as a seed or a key itself to perform data encryption processing. Objects to be encrypted may include a PUF value itself, image information, an amount of characteristic based on image information, and the like. By performing the encryption processing using the eigenvalue generated by the eigenvalue calculation unit 210, the solid-state imaging device 1 can encrypt data very securely.

The communication control unit 214 transmits data to the outside of the solid-state imaging device 1. The communication control unit 214 may perform different types of processing in a case of outputting imaging data and in a case of outputting data encrypted by the encryption unit 212.

By having such a configuration, the solid-state imaging device 1 according to the embodiment of the present disclosure can minimize side-channel leaks that can be generated before completion of an analog-to-digital conversion by the PUF implemented as a physical parameter, thereby making it difficult for an attacker to attack.

[1.3. Operation example]

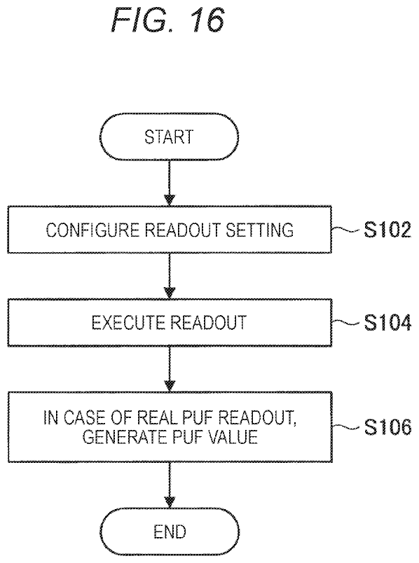

Next, an operation example of the solid-state imaging device 1 according to the embodiment of the present disclosure will be described. FIG. 16 is a flowchart illustrating an operation example of the solid-state imaging device 1 according to the embodiment of the present disclosure. The flowchart illustrated in FIG. 16 illustrates a flow from startup of the solid-state imaging device 1 to generation of a PUF value from an analog electric signal.

After startup, the solid-state imaging device 1 configures a readout setting (step S102). The readout setting is executed by the readout control unit 202, for example. Such readout settings may include the number of times and the position of readout from the pixel array unit 204 for dummy PUF readouts, the timing and the position of readout from the pixel array unit 204 for a real PUF readout, an analog-to-digital conversion setting of the analog-to-digital conversion unit 208, and the like. Furthermore, the solid-state imaging device 1 may configure a readout setting by using a random number generated by a random number generator. Furthermore, the solid-state imaging device 1 may configure a readout setting by using information stored in the storage unit 206.

After configuring the readout setting, the solid-state imaging device 1 executes a series of readouts based on the readout setting (step S104). The series of readouts is executed by, for example, the readout control unit 202.

After executing the series of readouts, in a case of a real PUF readout, the solid-state imaging device 1 generates a PUF value on the basis of the readout (Step S106). The PUF value is generated by, for example, the eigenvalue calculation unit 210. Here, the eigenvalue calculation unit 210 may also generate dummy PUF values on the basis of the dummy readouts. This makes it possible to minimize side-channel leaks at a digital circuit.

The solid-state imaging device 1 according to the embodiment of the present disclosure executes such a series of operations to minimize side-channel leaks that can be generated before completion of an analog-to-digital conversion by the PUF implemented as a physical parameter, thereby making it difficult for an attacker to attack.

[1.4. Modified example]

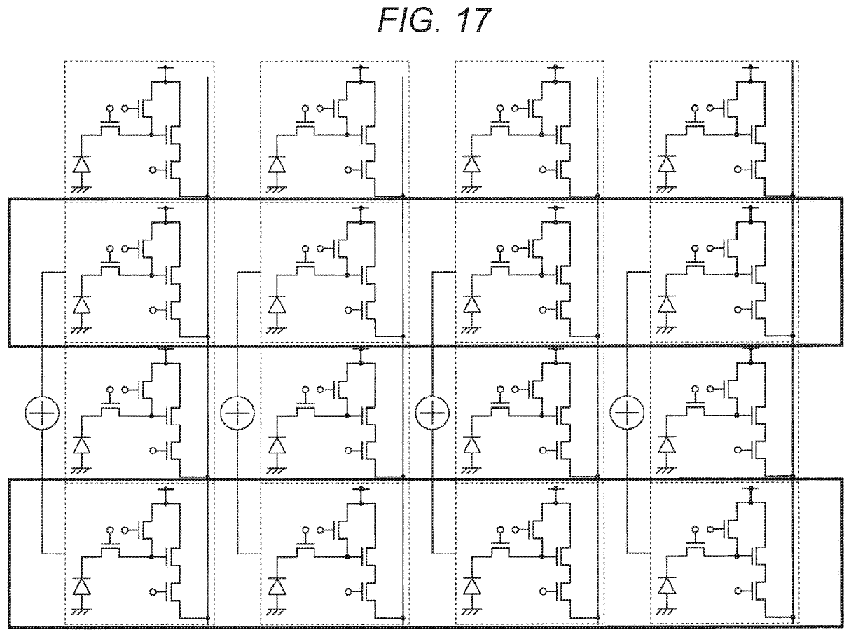

Next, modified examples of a dummy PUF readout of the present embodiment will be described. FIGS. 17 to 19 are explanatory diagrams illustrating modified examples of a dummy PUF readout executed by the solid-state imaging device 1 according to the embodiment of the present disclosure.

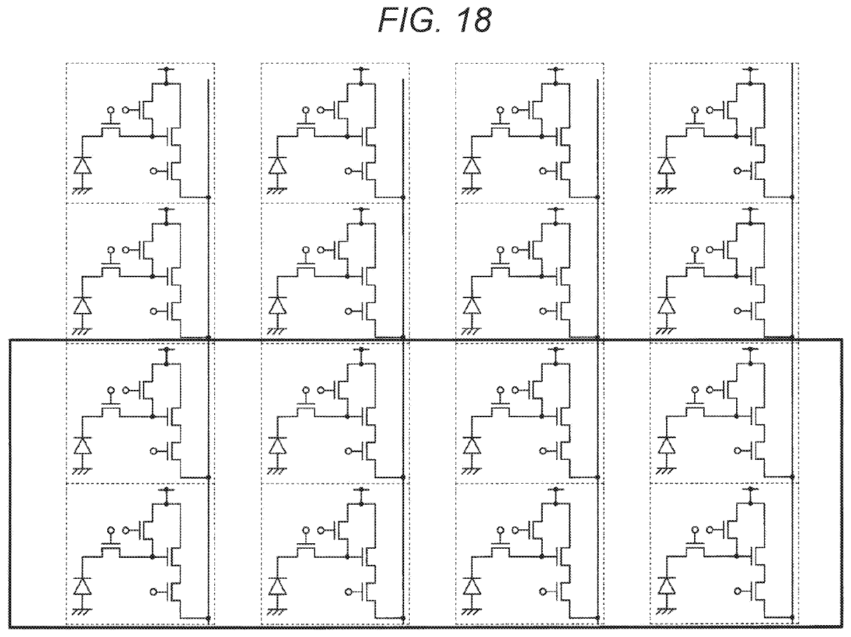

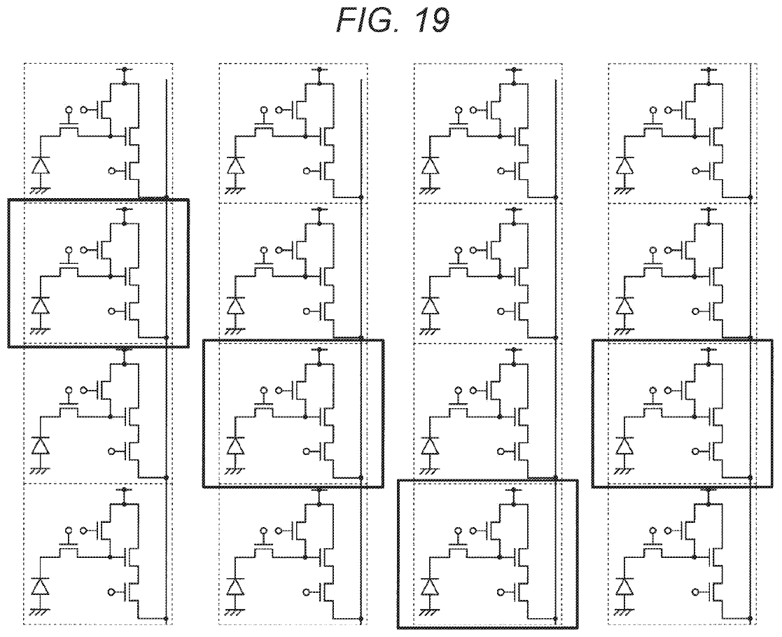

The solid-state imaging device 1 according to the present embodiment may perform, as a dummy PUF readout, an operation of reading out at least two rows apart from each other, such as those indicated by solid lines in FIG. 17, for example, and then adding up the readout results. Furthermore, the solid-state imaging device 1 according to the present embodiment may perform, as a dummy PUF readout, an operation of reading out at least two adjacent rows, such as those indicated by a solid line in FIG. 18, for example, and then adding up the readout results. The solid-state imaging device 1 according to the present embodiment may perform, as a dummy PUF readout, an operation of reading out pixels in different rows on a column-by-column basis, such as those indicated by solid lines in FIG. 19, for example.

Furthermore, besides the examples illustrated in FIGS. 17 to 19, the solid-state imaging device 1 according to the present embodiment can execute a variety of readouts. For example, the solid-state imaging device 1 according to the present embodiment may combine the readouts illustrated in FIG. 17 with the readouts illustrated in FIG. 18 and then execute an operation of adding up a plurality of results of reading out at least two adjacent rows. Furthermore, the solid-state imaging device 1 according to the present embodiment may combine the readouts illustrated in FIG. 17 or 18 with the readouts illustrated in FIG. 19 and then execute an operation of adding up two or more readouts of pixels in different rows on a column-by-column basis, or execute an operation of adding up two or more readouts of pixels in at least two adjacent rows that are different on a column-by-column basis.

Then, also in this modified example, the solid-state imaging device 1 according to the present embodiment may determine a setting of a real PUF readout or a dummy PUF readout on the basis of a random number.

### 2. Summary

As described above, the embodiment of the present disclosure can provide the solid-state imaging device 1 capable of minimizing side-channel leaks that can be generated before completion of an analog-to-digital conversion by the PUF implemented as a physical parameter, thereby making it difficult for an attacker to attack.

The steps in the processing executed by each device in the present specification do not necessarily need to be processed in a time series manner in the order described as a sequence diagram or a flowchart. For example, the steps in the processing executed by each device may be processed in an order different from the order described as a flowchart, or may be processed in parallel.

Furthermore, it is also possible to create a computer program for causing hardware such as a central processing unit, a read only memory, and a random access memory built in each device to exhibit a function equivalent to the configuration of each device described above. Furthermore, it is possible to provide a storage medium in which the computer program is stored. Furthermore, by configuring each functional block illustrated in the functional block diagram by hardware, the series of processing can be implemented by hardware.

The preferred embodiment of the present disclosure has been described above in detail with reference to the accompanying drawings, but the technical scope of the present disclosure is not limited to such an example. It is obvious that a person having ordinary knowledge in the technical field of the present disclosure can come up with various changes and modifications within the scope of the technical idea described in the claims, and such various changes and modifications are naturally understood to belong to the technical scope of the present disclosure.

Furthermore, the effects described in the present specification are merely illustrative or exemplary, and are not restrictive. That is, the technology according to the present disclosure can exhibit other effects that are obvious to those skilled in the art from the description in the present specification, in addition to or instead of the above effects.

Note that the following configurations also belong to the technical scope of the present disclosure.

(1)

A control device including:

a device unit that has regularly arranged analog devices; and

a readout control unit that executes readouts that are a mixture of a first readout that generates unique information for the device unit and a second readout that does not generate unique information for the device unit.

(2)

The control device according to (1), in which

the readout control unit obtains a mixture of the first readout and the second readout by changing a position of readout from the device unit.

(3)

The control device according to (1) or (2), further including

an analog-to-digital conversion unit that converts an analog value output from the device unit to a digital value,

in which the readout control unit obtains a mixture of the first readout and the second readout by changing a setting of the analog-to-digital conversion unit.

(4)

The control device according to any one of (1) to (3), in which

the readout control unit obtains a mixture of the first readout and the second readout on the basis of randomly generated random information.

(5)

The control device according to (4), in which

the readout control unit determines a position of readout from the device unit on the basis of the random information.

(6)

The control device according to (4) or (5), in which

the readout control unit determines the number of times of the second readout from the device unit on the basis of the random information.

(7)

The control device according to any one of (4) to (6), in which

the readout control unit determines a timing of the first readout from the device unit on the basis of the random information.

(8)

The control device according to any one of (4) to (7), further including

an analog-to-digital conversion unit that converts an analog value output from the device unit to a digital value,

in which the readout control unit determines a setting of the analog-to-digital conversion unit on the basis of the random information.

(9)

The control device according to any one of (4) to (8), in which

the random information is generated before processing of generating the unique information.

(10)

The control device according to any one of (4) to (9), further including

a storage unit that stores at least one of parameters of a function for generating the random information.

(11)

The control device according to any one of (1) to (10), in which

the readout control unit executes the first readout only once during a read interval.

(12)

A control method including

executing readouts that are a mixture of a first readout that generates unique information for a device unit that has regularly arranged analog devices and a second readout that does not generate unique information for the device unit.

(13)

A readout method including:

generating random information;

reading out a predetermined row in a pixel array including a plurality of rows on the basis of the random information;

generating unique information for a device on the basis of the readout of the predetermined row; and

generating dummy information on the basis of readout of a row other than the predetermined row.

(14)

The readout method according to (13), in which

the order of the plurality of rows to read out is controlled on the basis of the random information.

(15)

The readout method according to (13), in which

the unique information for the device is a PUF value.

(16)

The readout method according to (13), in which

the unique information for the device is related to a physical variable generated during manufacture of a semiconductor.

(17)

The readout method according to (13), in which

the random information is generated when an imaging device including the pixel array is powered on.

(18)

The readout method according to (17), in which

the random information is generated on the basis of a drive circuit of the imaging device.

(19)

The readout method according to (13), in which

the unique information for the device is combined with the dummy information.

(20)

A computer program that

generates random information;

reads out a predetermined row in a pixel array including a plurality of rows on the basis of the random information;

generates unique information for a device on the basis of the readout of the predetermined row; and

generates dummy information on the basis of readout of a row other than the predetermined row.

(21)

A readout device including:

a processor; and

a memory that stores a program that can be executed by the processor;

in which

the program:

generates random information;

reads out a predetermined row in a pixel array including a plurality of rows on the basis of the random information;

generates unique information for a device on the basis of the readout of the predetermined row; and

generates dummy information on the basis of readout of a row other than the predetermined row.

### REFERENCE SIGNS LIST

1 Solid-state imaging device
2 Pixel
3 Pixel array
4 Vertical drive circuit
5 Column signal processing circuit
6 Horizontal drive circuit
7 Output circuit
8 Control circuit
9 Vertical signal line
10 Horizontal signal line
11 Semiconductor substrate
12 Input/output terminal

1. A control device comprising:
a device unit that has regularly arranged analog devices; and
a readout control unit that executes readouts that are a mixture of a first readout that generates unique information for the device unit and a second readout that does not generate unique information for the device unit.

2. The control device according to claim 1, wherein
the readout control unit obtains a mixture of the first readout and the second readout by changing a position of readout from the device unit.

3. The control device according to claim 1, further comprising
an analog-to-digital conversion unit that converts an analog value output from the device unit to a digital value,
wherein the readout control unit obtains a mixture of the first readout and the second readout by changing a setting of the analog-to-digital conversion unit.

4. The control device according to claim 1, wherein
the readout control unit obtains a mixture of the first readout and the second readout on a basis of randomly generated random information.

5. The control device according to claim 4, wherein
the readout control unit determines a position of readout from the device unit on a basis of the random information.

6. The control device according to claim 4, wherein
the readout control unit determines the number of times of the second readout from the device unit on a basis of the random information.

7. The control device according to claim 4, wherein
the readout control unit determines a timing of the first readout from the device unit on a basis of the random information.

8. The control device according to claim 4, further comprising
an analog-to-digital conversion unit that converts an analog value output from the device unit to a digital value,
wherein the readout control unit determines a setting of the analog-to-digital conversion unit on a basis of the random information.

9. The control device according to claim 4, wherein
the random information is generated before processing of generating the unique information.

10. The control device according to claim 4, further comprising
a storage unit that stores at least one of parameters of a function for generating the random information.

11. The control device according to claim 1, wherein
the readout control unit executes the first readout only once during a read interval.

12. A control method comprising
executing readouts that are a mixture of a first readout that generates unique information for a device unit that has regularly arranged analog devices and a second readout that does not generate unique information for the device unit.
